(19) United States
(12) Patent Application Publication
(10) Pub. No.: US 2025/0056223 A1
(43) Pub. Date: Feb. 13, 2025

(54) PERSONALIZED WI-FI SYSTEMS AND METHODS

(71) Applicant: PHYTunes, Inc., Palo Alto, CA (US)

(72) Inventors: Chan-Soo Hwang, Cupertino, CA (US); Jisung Oh, Palo Alto, CA (US); Akula Aneesh REDDY, San Jose, CA (US); Kenneth R. Cioffi, San Jose, CA (US)

(73) Assignee: PHYTunes, Inc., Palo Alto, CA (US)

(21) Appl. No.: 18/233,313

(22) Filed: Aug. 12, 2023

(51) Int. Cl. H04W 12/06

(52) U.S. Cl. CPC H04W 12/06; H04W 84/12

(57) ABSTRACT

Described herein are systems and methods that use Ethernet infrastructure to extend the reach of Wi-Fi signals. As a result, the Wi-Fi coverage area of, e.g., an access point can be extended through building structures, such as walls, floors, and other obstacles. In certain embodiments, this is accomplished by utilizing an RF tuner that receives a signal produced from a Wi-Fi signal and recreates the Wi-Fi signal to retransmit it at a remote location that is outside of the regular coverage area of the access point.

### BACKGROUND

### A. Technical Field

The present disclosure relates generally to systems and methods for information handling systems, such as networking devices. More particularly, the present disclosure relates to personalized Wi-Fi systems and methods that improve the ease of interfacing with one or more information handling systems.

### B. Background

Wireless infrastructure, such as wireless access points, are known to have limited coverage area due to the range of their wireless signals being limited by surrounding building structures, such as walls, floors, and other obstacles. Accordingly, what is needed are systems and methods that can extend the coverage area of existing wireless infrastructure beyond their point of origination, ideally, without having to undertake major or costly redesigns.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments. Items in the figures are not to scale.

FIG. 1 illustrates an exemplary personalized wireless information handling system according to various embodiments of the present disclosure.

FIG. 2 is an exemplary block diagram of illustrating a personalized wireless information handling system according to various embodiments of the present disclosure.

FIG. 3 illustrates an information handling system for multiplexing control, power, and wireless signals over different cables and frequencies, according to various embodiments of the present disclosure.

FIG. 4A and FIG. 4B illustrate exemplary time-division multiplexing approaches for multiplexing control, power, and wireless signals according to various embodiments of the present disclosure.

FIG. 5 provides additional details on how an information handling system like that shown in FIG. 2 may control transmission between RF tuners and a headend unit according to various embodiments of the present disclosure.

FIG. 6 illustrates the effect of a network manager on a headend unit according to various embodiments of the present disclosure.

FIG. 7 illustrates physical layer security according to various embodiments of the present disclosure.

FIG. 8A illustrates an information handling system that utilizes a radio tuner that allows common Ethernet devices to be combined with and share a connection to a headend unit according to various embodiments of the present disclosure.

FIG. 8B is an exemplary block diagram for the exemplary radio tuner shown in FIG. 8A.

FIG. 9A illustrates cascaded radio tuner system according to various embodiments of the present disclosure.

FIG. 9B is an exemplary block diagram of radio tuner 1 shown in FIG. 9A.

FIG. 10 is a flowchart of an illustrative process for using a headend unit to establish a communication to a remotely located user equipment in accordance with various embodiments of the present disclosure.

FIG. 11 is a flowchart of an illustrative process for forming a personalized virtual local area network (VLAN), the method comprising in accordance with various embodiments of the present disclosure.

FIG. 12 depicts a simplified block diagram of a computing device/information handling system (or computing system) according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system/device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. The terms “include,” “including,” “comprise,” “comprising,” and any of their variants shall be understood to be open terms, and any examples or lists of items are provided by way of illustration and shall not be used to limit the scope of this disclosure. Each reference/document mentioned in this patent document is incorporated by reference herein in its entirety.

In this document the term “RF tuner” refers to a “radio node” or “distribution node.” A headend unit refers to device that may perform functions of an “intermediate node” as described in U.S. patent application Ser. No. 18/197,990, filed on May 16, 2023, entitled “Packetization within Multi-Stream Wireline-Wireless Physically Converged Architectures,” and listing as inventors Akula Aneesh Reddy, Jisung Oh, and Vinay Joseph, which application is herein incorporated by reference as to its entire content.

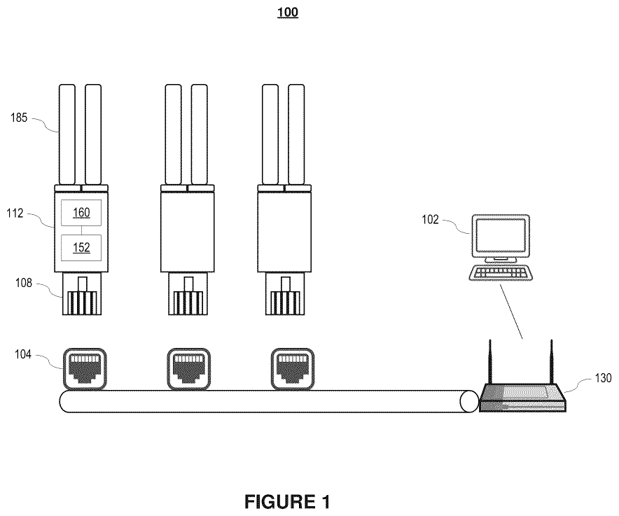

FIG. 1 illustrates a personalized wireless information handling system according to various embodiments of the present disclosure. In embodiments, personalized wireless system 100 may comprise management server 102, connector 104, socket 108, headend unit 130, one or more cables 166 (e.g., Ethernet cables), and RF module 112, which may comprise RF tuner (e.g., 160) and authenticator unit 152. In embodiments, RF module 112, may be implemented as a portable device and serve as a portable radio node. In embodiments, authenticator unit 152 may comprise a biometric ID reader, such as a fingerprint or facial reader that may be used to authorize or authenticate a user to RF module 112, e.g., prior to headend unit 130 enabling a wireless signal at one or more antennae of RF tuner 160.

As depicted, connector 104 may be implemented as an RJ45-type connector, and socket 108 may be an RJ45-type wall jack for wireline 166, which, as discussed further below, may be implemented as an Ethernet cable that allows for multiplexing several twisted pair cables, however, this is not intended as a limitation on the scope of the present disclosure since any suitable transmission line may be employed to accomplish the objectives of the disclosure. For example, shielded cable may be used to further reduce crosstalk and other unwanted effects resulting from static and electromagnetic fields, such as crosstalk within a bundle of cables.

In embodiments, headend unit 130 may be implemented a dedicated device or may be integrated, e.g., into a common Wi-Fi access point or base station that, in operation, may serve as a Wi-Fi gateway. Similarly, management server 102 may be implemented a dedicated device or may be integrated into, e.g., headend unit 130.

In operation, personalized wireless system 100 may be used to transmit RF signals, such as a Wi-Fi signal, through a physical transmission line, such as cable 166, which may be routed through building structures, such as walls, floors, and other obstacles that, otherwise, would interfere with the Wi-Fi signal. As such, the Wi-Fi signal of headend unit 130 in system 100 may be thought of as being extended by cable 166. Such embodiments advantageously extend signal coverage, without having to switch between coverage areas, switch service set identifications (SSIDs), or suffer significant connection delays or losses. Once RF tuner (e.g., 160) in RF module 112 recovers the received Wi-Fi signal, it may retransmit the signal to a user equipment (UE) (not shown in FIG. 1), such as a cell phone.

In embodiments, authentication unit 152 in RF module 112 may be used to establish a secure Wi-Fi signal, e.g., within 100 msec, according to various embodiments herein. Once RF module 112 is coupled to port 108, a Wi-Fi connection may be established, and once a Wi-Fi connection is no longer necessary, RF module 112 may be disconnected from port 108.

In detail, in embodiments, in response to a user entering an access-controlled area, such as a room, office, or the like, management server 102 may be notified, e.g., by an access control unit (not shown in FIG. 1) and cause headend unit 130 to enter a standby mode, such that RF tuner 160 may be enabled in the corresponding port 104 once connector 108 is plugged in.

In embodiments, coupling RF module 112 into ports 104 may cause a wired local area network (LAN) connection to be established between RF module 112, headend unit 130 and/or management server 120. In embodiments, authenticator unit 152 may authenticate RF tuner 160 to the network, e.g., by communicating to management server 102 the module's unique ID, which may be pre-registered with management server 102 and may be different from the module's MAC address. Alternatively, management server 102 may instruct headend unit 130 to share a hardware key (i.e., a pre-shared key) with RF module 112. Once RF module 112 has been authenticated, RF tuner 160 may communicate with headend unit 130 and/or management server 102, e.g., using a secure wireline local area network (LAN) connection that employs is secured with an encryption method.

In embodiments, auser equipment (not shown in FIG. 1) may be used to authenticate a user. For example, e.g., in response to a communication between a user equipment and RF module 112, authenticator unit 152 or the user equipment may collect a unique ID such as authentication signature (e.g., a password, passcode or biometric ID from a fingerprint or facial reader) that may be implemented in authenticator unit 152 within RF module 160 to authenticate and authorize the user to the RF module, e.g., prior to headend unit 130 enabling a wireless signal at RF tuner 160. The authentication information may be passed to the network manager or management server 102 to remotely perform user authentication prior to enabling a Wi-Fi connection between, e.g., the user equipment and headend unit 130. It is understood that the network manager or management server 102 may collaborate with any existing access control system to further enhance security.

Advantageously, enabling the Wi-Fi connection, need not negatively impact any preexisting Wi-Fi connections of headend unit 130. Similarly, in embodiments, disconnecting RF module 112 from cable 166 need not impact other users that remain connected and continue to obtain signals from other RF modules.

In embodiments, a Wi-Fi beacon signal may be present, e.g., every 100 msec. Once the user equipment decodes the first beacon signal, it may connect to headend unit 130. In addition, when the user equipment (e.g., cell phone) is in motion, management server 102 may control the transmit power of RF module 112 to ensure good coverage for the authorized user within the range of RF module 112.

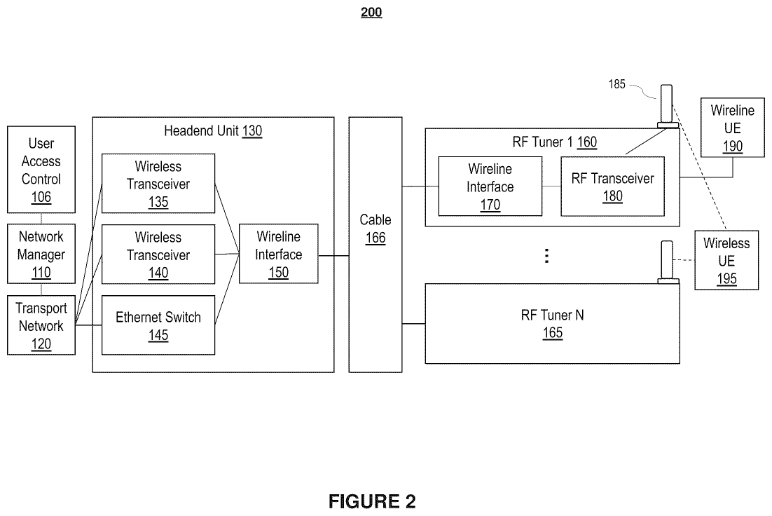

FIG. 2 is a block diagram of illustrating a personalized wireless information handling system according to various embodiments of the present disclosure. Same numerals as in FIG. 1 denote similar elements. As depicted, system 200 in FIG. 2 may comprise headend unit 130, cable, RF Tuner 1 160, antenna 185, wireline user equipment (UE) 190, user access control unit 106, wireless (Wi-Fi) transceiver 135, wireline interface 150 and 170, respectively, cable 166, RF transceiver 180, network manager 110, transport network 120, wireless (e.g., cellular) transceiver 140, Ethernet switch 145, RF Tuner N 165, and wireless UE 195. It is understood that one or more of user access control unit 106, network manager 110, and transport network unit 120 may be integrated into management server 102. It is further understood that management server 102 may be implemented a distributed system of management servers.

In embodiments, headend unit 130 may be coupled to transport network 120 to connect to an outside network, such as the Internet, EPC (LTE core), and 5GC (5G core). In embodiments, transport network 120 may couple headend unit 130 to other network entities (NE) in the access network (e.g., radio unit (RU), distributed unit (DU), centralized unit (CU), and the like). Headend unit 130 may comprise wireless transceivers 135, 140 and wireline interface 150. Wireless transceivers 135, 140 may be implemented as Wi-Fi or cellular (e.g., LTE, 5G, 6G, etc.) transceivers that, in embodiments, feed a least a portion of a set of wireless RF signals as wireline signals, which may comprise RF-modulated information, to cable 166 (e.g., over wireline interface 150).

Network manager 110 may interact with user access control unit 106 to provide communication access to users having legitimate access to an area in which RF tuner 160 is present. For example, access control unit 106 may control user access to a room or entire building using sensors, access card readers, or any other access control method known in the art to authenticate a user. Access control unit 106 may communicate with network manager 110, e.g., via an application programming interface (API), to indicate to network manager 110 that the authenticated user will be commencing a further authentication process to authorize an RF tuner or to authorize the access to an RF tuner. In embodiments, network manager 110 may be coupled to headend unit 130 and RF tuners 160-165, e.g., to control configuration parameters and provide a more secure network. For example, network manager 110 may change a channel frequency of Wi-Fi transceiver 135 if a Wi-Fi network that network manager 110 cannot control is in the coverage area of one of RF tuners 160-165. In embodiments, wireline interface 150 and RF tuners 160-165 may have unique network addresses (e.g., IP addresses). Network manager 110 may using such unique addresses to send/receive instructions via wireline interface 150 and RF tuners 160-165 using an API.

In embodiments, wireline interface 150 may be used to condition the RF signal to obtain a wireline signal, which is a conditioned RF signal, before transmitting or receiving the wireline signal via cable 166. In embodiments, signal conditioning may comprise one or more of an amplification, attenuation, filtering, and/or frequency translation operation, signal splitting, signal combining, signal selection, impedance matching of input and output signals, signal conversion, e.g., between single-ended and balanced signals, and other operations.

In embodiments, wireless transceiver 135, 140 may output one or more control signals to provide a timing reference to and/or to control wireline interface 150. A suitable control signal may be transmitted to RF tuners 160-165 to control them and provide a timing reference. The control signal may further comprise a transmit-receive switching (TRSW) signal, e.g., for switching wireline interface 150 and RF tuner 160 between transmission and receiver modes in synchronization with a particular mode of wireless transceiver 135. In embodiments, the timing reference may be a clock signal that has been produced by wireless transceiver 135, e.g., to synchronize frequency synthesizers, transmitter/receiver switching of wireline interfaces 150 and 170, respectively, and RF tuners 160-165. Wireline interface 150 in headend unit 130 may send control signals to RF tuner 160-165 via cable 166 as the transmission medium.

In embodiments, the control signals may be multiplexed with the wireline signal, e.g., by utilizing different frequency carrier, time, or transmission modes of cable 166. As a person of skill in the art will appreciate, transmission modes in a cable may comprise common and differential modes of a twisted pair in a cable, or a transmission mode in a different twisted pair in the cable.

Power over Ethernet (PoE) switch 145 in headend unit 130 may provide wireline communications access and power to RF tuners 160-165. In embodiments, PoE Ethernet switch 145 may receive management commands from network manager 110 and deliver commands to an appropriate destination, such as wireline interface 150 or RF tuners 160-165. A management command may comprise instructions on one or more of the following: adjusting transmission power of RF tuners 160-165; turning on/off RF tuners 160-165; changing the wireline interface settings at wireline interface 150 and RF tuners 160-165; authenticating and authorizing RF tuners 160-165; upgrading or rolling back software versions (such as firmware or device drivers) in RF tuners 160-165; providing command line interface (CLI) to wireline interface 150 and RF tuners 160-165; collecting information about UEs in the vicinity of RF tuners 160-165; collecting information about interferers or other APs near RF tuners 160-165; collecting alarm information about the operational anomalies of wireline interface 150 or RF tuners 160-165, such as abrupt gain change or loss of synchronization between wireline interfaces and about operational conditions of cable 166, such as a loss or abrupt change in the wireline signal; gathering cable/RF tuner/wireless UE/wireline UE information; and other management instructions, e.g., for collecting log information and adjusting configurations of wireline interface 150 and RF tuners 160-165.

In embodiments, RF tuner 160 may comprise wireline interface 170, RF transceiver 180, and antenna 185. In embodiments, wireless UE (e.g., 195) may be coupled to wireless transceiver 135 via antenna 185, RF transceiver 180, and wireline interfaces 170 and 150. Antenna 185 converts radio wave to RF signal or vice versa. RF transceiver 180 may receive and amplify conditioned RF signals from wireline interface 170, and transmit radio waves via antenna 185. Conversely. RF transceiver 180 may receive RF signals from antenna 185, amplify the RF signals and then pass them to wireline interface 170. Wireline interface 170 may perform one of more of the following functions: exchanging (transmitting or receiving) wireline signals with wireline interface 150 (e.g., via cable 166) and exchanging conditioned RF signals with RF transceiver 180; receiving control signals from headend unit 130; exchanging Ethernet packets with Ethernet switch 145; processing management commands of network manager 110; and receiving power from PoE switch 145. Wireline interface 150 may perform one of more of the following functions: exchanging (transmitting or receiving) wireline signals with wireline interface 170 (e.g., via cable 166) and exchanging conditioned RF signals with wireless transceiver 135, 140; receiving control signals from headend unit 130; exchanging Ethernet packets with Ethernet switch 145; processing management commands of network manager 110; and transmit power from PE switch 145 to wireline interface 170 (e.g., via cable 166). In embodiments, wireline UE (e.g., 190) may be coupled to Ethernet switch 145 via wireline interface 170, which may perform one of more of the functions: exchanging Ethernet packets with Ethernet switch 145 using Ethernet protocol (e.g., 100Base-T); processing management commands of network manager 110; and receiving power from PoE switch 145.

In embodiments, RF tuners (e.g., 165) may be added to or removed from a network that may be formed by headend unit 130 and RF tuners 160-165, advantageously, without affecting the operation of each other. This is because RF tuners 160-165 are synchronized with wireless transceiver 135 by using the control signal and the RF signals transmitted from more than one RF tuner may be linearly combined by wireline UE's wireless transceivers, and the linear combination of RF signals from a wireless UE 195 via different RF tuners 160-165 may be demodulated by wireless transceiver 135, 140.

In embodiments, assuming wireless transceiver 135 transmits signal x(t) and the RF tuners 160-165 and head-end 130 unit are synchronized, the signal received at wireless UE 190 from RF tuner is y₁(t)=A₁x(t−T₁)+n₁(t), where T₁ is the total propagation delay, A₁ is the total gain/attenuation, and n₁(t) is sum of noises in respective wireline interfaces 150, 170, cable 166, and RF transceiver 180. The wireless UE 195 can demodulate y₁(t) if y₁(t) is received with a sufficiently large signal-to-noise ratio (SNR) and the propagation delay T₁ remains within certain limits.

For example, if signal (t) was modulated by using a multi-carrier modulation (e.g., OFDM), the delay limit is determined by the length of the cyclic prefix (CP). Once a new RF tuner is added, wireless UE 195 receives signal y₂(t)=A₂x(t−T₂)+n₂(t) from the newly added RF tuner, and wireless UE 195 may successfully demodulate the mixture of y₁(t) and y₂(t) if delays T₁ and T₂ remain within the set delay limit. As an example, using a multi-carrier modulation such as OFDM, if delays T₁ and T₂ are within the CP length, a conventional multi-carrier demodulator can demodulate the mixture of y₁(t) and y₂(t) because a conventional demodulator can resolve the multi-path channel if the delay of each path is within the CP length. It is understood that the transmit signal (t) may be formed by multiple antennas and that signals y₁(t) and y₂(t) may be received by multiple antennas.

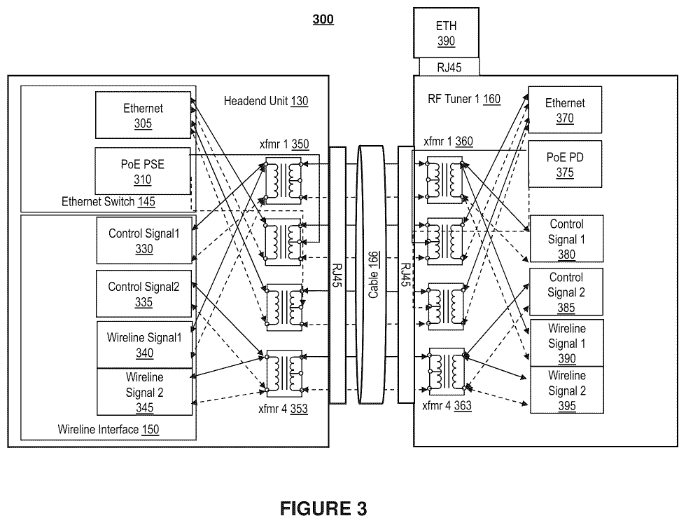

FIG. 3 illustrates a system for multiplexing control, power, and wireless signals over different cables and frequencies, according to various embodiments of the present disclosure. In embodiments, system 300 may comprise headend unit 130, which may comprise PoE Ethernet Switch 145, wireline interface 150, and transformers 350-353. As depicted, RF tuner 1 160, which may be a PoE powered device, may comprise transformers 350-363 and couple to headend unit 130 via cable 166 using RJ45-type connectors.

In operation, wireline interface 150 may generate control signal 1 330, control signal 2 335, wireline signal 1 340, and wireline signal 2 345. Similarly, RF tuner 1 160 may receive control signal 1 380, control signal 2 385, wireline signal 1 390, and wireline signal 2 395. In embodiments, control signal 1 330 may be a TRSW signal and control signal 2 335 may be a clock signal, previous mentioned with reference to FIG. 2 above.

In embodiments where cable 166 comprises four twisted pairs, wireline interfaces 150, 170 use two pairs in cable 166 for transmitting Ethernet and PoE signals and the remaining two pairs may be used to transmit and receive wireline and/or control signals. The wireline signals and control signals may be multiplexed in the frequency domain and/or the time domain.

In embodiments, where cable 166 comprises a number of twisted pair wirings, e.g., four-pair cabling in an Ethernet cable, wireline interface 150 may utilize a subset of spare pairs that are not used for certain Ethernet physical layers. As an example, wireline interface 150 may use pair 1 and 4 for transmitting RF/control signals and PoE Ethernet switch 145 may use pair 2 and 3 for transmitting Ethernet and PoE signals. Such an assignment of twisted pairs works well with 10Base-T and 100Base-T Ethernet connections that typically use pair 2, 3 to operate.

In embodiments, Ethernet headend unit 130 and Ethernet in RF tuner 160 may use the differential mode of pair 2, 3. PoE signals may use common mode signals of the same twisted pair 2, 3. Common mode transmission is similar to PoE methods, where PoE outputs are connected to the center tap of the twisted pair 2, 3. This is commonly used in 10BaseT and 100BaseT PoE switches. If there are multiple antennas in wireless transceivers 135, 140 (shown in FIG. 2), the wireline signal corresponding to the RF signal for each antenna may use pins 1 and 4. If there are more than two transmit antennas, the wireline signals corresponding to the RF signals from different antennas may be frequency-multiplexed in pair 1, 4. Similarly, if there is more than one control signal, those may be multiplexed in different pairs (e.g., clock in pair 1 and TRSW in pair 4) or in different frequency bands (e.g., TRSW baseband transmission, 30˜40 MHz clock signal, and wireline signals above 100 MHz).

As depicted in FIG. 3, the interface configuration at RF tuner 160 may match that in headend unit 130. Moreover, as mentioned in greater detail below, an additional Ethernet device may be connected to an RF tuner 160. Advantageously, this allows an Ethernet port to be shared by an RF tuner and a device without wireless capability that would otherwise fully occupy Ethernet the port.

In embodiments, while all four pairs of cable 166 may be used for wireline interface and Ethernet operations, wireline interface 150 may use a frequency above Ethernet frequencies, e.g., 100 MHz, such that Ethernet signals and the signals from wireline interface 150 can be multiplexed in different frequency bands. For example, Ethernet/PoE may use the Ethernet frequency band, while wireline interface 150 may transmit control signals/wireline signals at a frequency band that lies above the Ethernet frequency band.

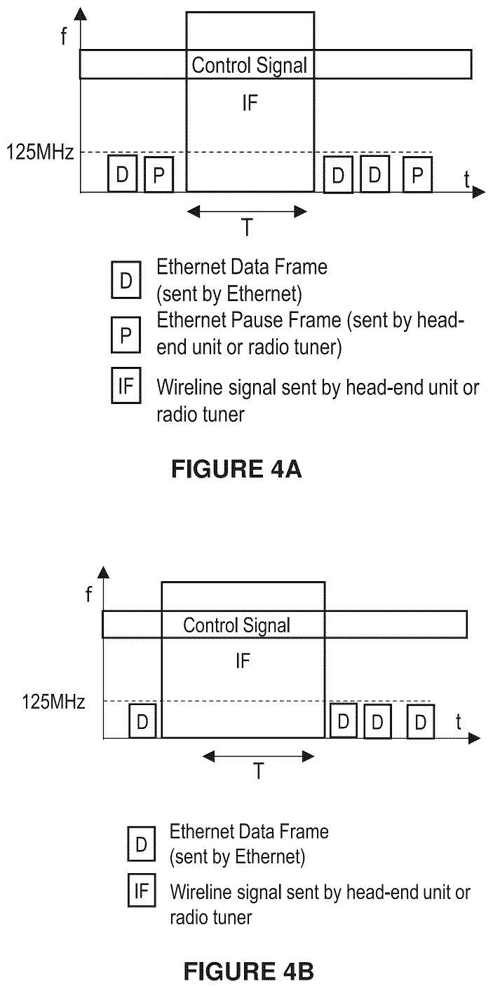

FIG. 4A and FIG. 4B illustrate exemplary time-division multiplexing approaches for multiplexing control, power, and wireless signals according to various embodiments of the present disclosure. FIG. 4A depicts a scheme using multiplexing operations that involve protocol spoofing, and FIG. 4B depicts a scheme that involves physical switching. In embodiments, time-multiplexing Ethernet and wireline interface signals may comprise halting Ethernet signals in favor of transmitting wireline interface signals. As an example, a wireline interface for transmitting wireline signals over an Ethernet cable may transmit an Ethernet pause frame to temporarily halt Ethernet transmissions on the cable and, once the Ethernet signals have been halted in this manner, the Ethernet cable may transmit a set of wireline signals until resuming with transmitting Ethernet signals again. Advantageously, such approaches enable the wireline interface to use the Ethernet's frequency band, while preventing unwanted interference between Ethernet and wireline interfaces.

In embodiments, the wireline interface may convey a control signal above the Ethernet's frequency band, such that the control signal can be conveyed continuously while wireless signals are exchanged intermittently. Similarly, the wireline interface may convey a power signal below the Ethernet's frequency band, such that the power signal can be conveyed continuously.

In embodiments, a wireline interface and Ethernet signals may be coupled to a wireline via a switch that may be embedded, e.g., in a headend unit (not shown) and that may select the type of signals to be transmitted at any moment in time by physically switching between signals. For example, when the wireline interface transmits a signal, the switch cause the wireline signal to be connected to the cable such that all Ethernet communication is dropped until the wireline interface stops using the cable, at which time Ethernet traffic may resume. It is understood that, in embodiments, time-multiplexing may further be used to multiplex various networks. Furthermore, any other multiplexing schemes, such as spread spectrum multiple access, may equally be employed to accomplish the objectives of the present disclosure.

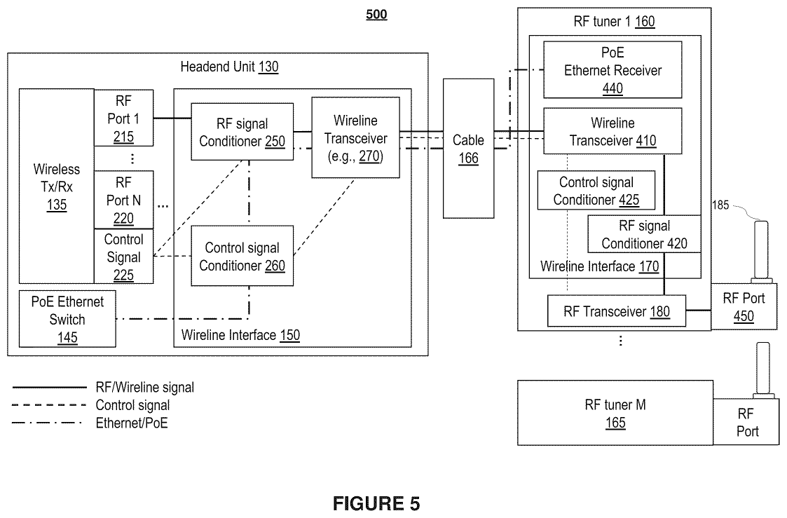

FIG. 5 provides some additional details on how an information handling system like that shown in FIG. 2 may control transmissions between RF tuners and a headend unit according to various embodiments of the present disclosure. For clarity, components similar to those shown in FIG. 2 are labeled in the same manner. For purposes of brevity, a description or their function is not repeated here. In embodiments, wireline interface 150 in system 500 may comprise RF signal conditioner 250 and control signal conditioner 260. As depicted, headend unit 130 may comprise PoE Ethernet switch 145, which may provide power to RF tuner 160.

RF tuner 160 may comprise RF port 450 and wireline interface 170 that may comprise RF signal conditioner 420 and control signal conditioner 425. It is understood that control signal conditioners 260, 425 and RF signal conditioners 250, 420 may comprise additional circuitry that may perform steps composing one or more of amplification, attenuation, filtering, or frequency translation.

In operation, wireline interface 150 may use wireless transceiver 270 to transmit a conditioned RF signal to RF tuner 160 through cable 166. RF signal conditioner 250 may condition the RF signal received at RF port 1 215, e.g., to generate a wireline signal that can be efficiently transmitted over cable 166, e.g., without losing information in the RF signal. RF signal conditioners 250, 420 may perform one or more signal processing steps, such as amplification, attenuation, filtering, frequency translation, and signal splitting, combining, selection, matching, and conversion. In embodiments, the wireline signal may be an intermediate frequency (IF) signal that has a lower carrier frequency than the RF signal's original carrier frequency. The IF carrier frequency may be set as the frequency that exhibits low attenuation with low noise/interference in cable 166.

For example, using an Ethernet cable, such as Cat-5e or Cat-6, the signal may propagate further and encounter less crosstalk in a lower frequency band. It is noted that in scenarios in which cable 166 is an unshielded Ethernet cable that uses the lower frequency band for Ethernet transmission, e.g., 100BaseT Ethernet that uses frequencies up to 125 MHz, in embodiments, to protect the Ethernet signal in the same cable or, e.g., in near-by cables within a bundle, wireline interface 150 may avoid transmission in the same Ethernet frequency band to reduce or prevent crosstalk.

In embodiments, RF signal conditioner 250 may comprise an amplifier or attenuator that allows the conditioned signal to avoid nonlinearities in wireline transceiver 270 or avoid harmful effects to other communication systems that utilize a frequency band near the IF frequency, e.g., a frequency between baseband and the RF frequency used by wireline transceiver 270. As an example, wireless transceiver 270 may transmit a signal having a sufficiently large amplitude to saturate various signal conditioning components such as amplifiers or mixers. Therefore, in embodiments, attenuation may be applied prior to transferring the signal from wireless transceiver 270 to RF signal conditioner 250. Further, in embodiments, when cable 166 is an unshielded cable, transmit power may be reduced, e.g., in response to a cable shield detector indicating an absence of a shield in cable 166. For example, a shield detector may determine the absence of a shield in response to detecting a relatively large amorous of RF interference (RFI) in a received signal.

In embodiments, control signal conditioner 260 in wireline interface 150 may receive control signals, e.g., at control signal port 225 and condition at least some of the control signals to more efficiently transmit them over cable 166. Suitable control signals may comprise a clock signal that may be transmitted from a clock buffer (not shown), and a TRSW signal that may be transmitted over the baseband, e.g., after being appropriately amplified.

Wireline transceiver 270 may transmit the conditioned signals from respective RF signal conditioner 250 and control signal conditioner 260 to RF tuners 160-165 through cable 166. It is understood that transmission may comprise power amplification, the use of multiplexers and line interface, and the like. In embodiments, a power amplifier may be used to output a conditioned signal with sufficient power to reach RF tuner 160 with an acceptable level of quality.

In embodiments, a multiplexer may multiplex wireline signals and/or control signals. Multiplexing of wireline and control signals may occur, e.g., at different frequency bands comprising LPF, BPF, or HPF. It is understood that, wireline interface 150 may generate a differential signal and apply impedance matching techniques to cable 166 to ensure signal integrity.

In addition, wireline interface 150 may comprise a set of transformers, such as those depicted in FIG. 3, which may be used to convert a single-ended signal to a balanced signal, e.g., to protect wireline transceiver 410 from external disturbances that may be caused by unwanted effects such as lightening that couples into cable 166. Further, wireline transceiver 270 may transmit Ethernet signals that may be multiplexed, and transmit power that has been received from PoE Ethernet switch 145 to cable 166.

In embodiments, wireline interface 170 at RF tuner 160 may comprise a line interface that may provide a single-ended signal from a balanced signal and perform impedance matching, a demultiplexer, a low-noise amplifier, etc. In embodiments, wireline interface 170 may receive a wireline signal from wireline transceiver 270. The demultiplexer may comprise LPF, BPF, and/or HPF such that wireline and control signals can be properly separated. An exemplary demultiplexer may separate the multiplexed signals comprising the wireline signal, control signal, Ethernet signal, and PoE signal.

RF signal conditioner 420 may condition received RF signals such that the wireline signal, i.e., the output of RF conditioner 420 corresponding to the RF signal, is amenable for transmission by RF transceiver 180. RF conditioner 420 may perform a frequency translation operation such that, in embodiments, the output RF signal has the same RF carrier frequency as the signal that is produced by wireless transceiver 135. It is understood that signal conditioning may further comprise filtering and attenuation/amplification operations.

In embodiments, control signal conditioner 425 may condition a received control signal and apply attenuation, amplification, or frequency translation to it, operations to split a control signal to many signals, impedance matching between input and output, such that the control signal can properly control RF tuner 160. For example, control signal conditioner 425 may pass a received clock signal to a phased-locked loop (not shown) such that an output clock exhibits low jitter and has an accurate frequency. As another example, a received TRSW signal may be passed to a buffer amplifier (also not shown) such that the resulting output voltage is suitable to trigger switching wireline interface 170 between transmission and receiver modes. In addition, PoE Ethernet receiver 440 may receive Ethernet packets and extract power from a PoE signal delivered by cable 166, e.g., by using PoE PD circuitry. RF transceiver 180 may receive the RF signal from wireline interface 170, amplify the signal, and transmit an RF wave from antenna 185. As person of skill in the art will appreciate, processes involving wireless transceiver 135 receiving RF signals generated by RF tuners 160-165 may follow analogous steps.

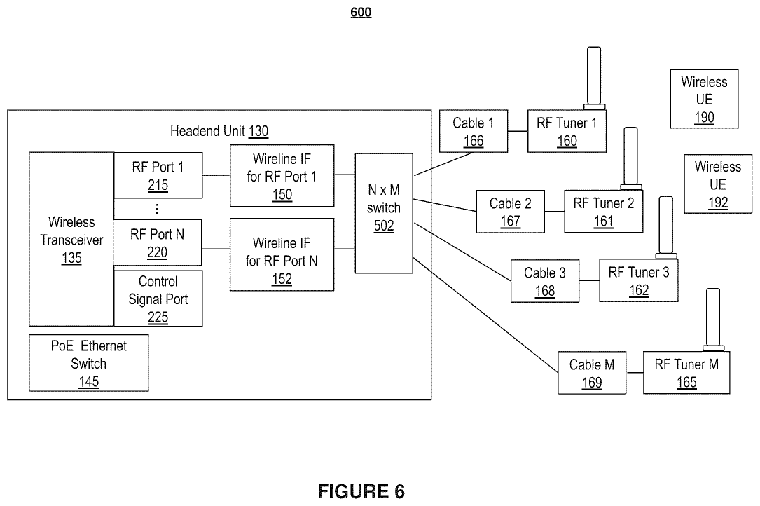

FIG. 6 illustrates the effect of a network manager on a headend unit according to various embodiments of the present disclosure. System 600 comprises headend unit 130, RF tuners 160-165, cables 166-169 (e.g., Ethernet cables), and wireless UE 190-192. Like the headend unit in FIG. 5, headend unit 130 in FIG. 6 may comprise wireless transceiver 135, RF ports 215-220, control signal port 225, wireline interface for RF port 1 150, wireline interface for RF port N 152, PoE Ethernet switch 145. In addition, headend unit 130 may further comprise N×M switch 502. It is understood that, e.g., in embodiments that do not utilize N×M switch 502, one or more of cables 166-169 may be directly connected to, e.g., wireline interface 1 150. It is further understood that this connection may be manually changed, e.g., upon receiving instructions from the network manager.

In operation, wireless transceiver 135 in headend unit 130 may receive a number N of antenna signals on N RF ports 215-220 and provide N signals to N wireline interfaces (e.g., 150). If M>N, switch 502 may receive the N signals and provide them as to a number of M cables (e.g., 166) that each may be coupled to a different RF tuner (e.g., 160). In embodiments, the output of, e.g., wireline interface 1 150 may process a signal received at RF port 215 to provide a wireline signal to each of a number of RF tuners by using a dedicated cable for each RF tuner. Conversely, wireline interface 1 150 may use switch 502 to provide a wireline signal to only one cable (e.g., 169) that may transmit the signal to two or more RF tuners.

As an example, wireline interface 1 150 may transmit the same signal x₁(t) to two different RF tuners 160 and 161, respectively. Assuming x₁(t) is a narrowband signal or corresponds to a specific sub-carrier of a multi-carrier modulated signal, the signal transmitted by RF tuner 1 160 may be expressed as y₁(t)=A₁x₁(t−T₁)+n₁(t), where T₁ represents the total propagation delay, A₁ represents the total gain/attenuation, and n₁(t) represents the noise. Similarly, the signal transmitted by RF tuner 2 161 may be expressed as y₂(t)=A₂x₁(t−T₂)+n₂(t). Ignoring propagation delay, wireless UE 190 will, thus, receive signal z₁(t)=B₁y₁(t)+B₂y₂(t)+nᵤ₁(t)=B₁A₁x₁(t−T₁)+B₂A₂x₁(t−T₂)+nᵤ₁(t), where nᵤ₁(t) represents the sum of receiver noise in wireless UE 190 and n₁(t), n₂(t). As long as T₁ and T₂ are shorter than the cyclic prefix length of the multicarrier modulated signal, B₁A₁x₁(t−T₁)+B₂A₂x₁(t−T₂) combine coherently. Advantageously, this increases signal power when compared to scenarios in which wireless UE 190 receives a signal from only one of RF tuners 160, 161. Further, because the received signal is a combination of signals that are passed through two independent wireless channels, B₁ and B₂, the diversity created thereby will cause the received signal to be more immune against wireless fading effects. As a result, at longer distances from RF tuners 160 and 161, wireless UE 190 may receive a more robust wireless signal.

In embodiments, wireline interface 1 150 may transmit a signal x₁(t) to RF tuner 1 160 and wireline interface 2 152 may transmit a signal x₂(t) to RF tuner 2 161. Assuming xᵢ(t) is the signal corresponding to a sub-carrier of a multi-carrier modulated signal, the transmit signal from RF tuner 1 160 may be expressed as y₁(t)=A₁x₁(t−T₁)+n₁(t), where, again, T₁ is the total propagation delay, A₁ is the total gain/attenuation, and n₁(t) is the noise. And the transmit signal from RF tuner 2 161 may be expressed as y₂(t)=A₂x₂(t−T₂)+n₂(t). Ignoring propagation delay, a first antenna of wireless UE 190 may receive signal z₁(t)=B₁₁y₁(t)+B₂₁y₂(t)+nᵤ₁(t)=B₁₁A₁x₁(t−T₁)+B₂₁A₂x₂(t−T₂)+nᵤ₁(t), where nᵤ₁(t) is the sum of receiver noise in the wireless UE 190 and n₁(t), n₂(t). Similarly, a second antenna of wireless UE 190 may receive z₁(t)=B₁₂A₁x₁(t−T₁)+B₂₂A₂x₂(t−T₂)+nᵤ₁(t). If T₁ and T₂ are shorter than the cyclic prefix length of the multicarrier modulated signal, a MIMO receiver at wireless UE 190 can thus decode both x₁(t) and x₂(t). Therefore, advantageously, wireless UE 190 may support higher data rates and/or throughput.

In embodiments, a network manager, such as that depicted in FIG. 2, may provide a mapping between N inputs and M outputs of N×M switch 502 that improves coverage and output of the network in which RF tuners 160-165 operate. For example, if a relatively large number of wireless UEs is present near two RF tuners that are adjacent to each other, the network manager may couple the two RF tuners to different ports (e.g., port 215 and 220) coupled to different wireline interfaces, or antenna signals, e.g., to increase throughput to the area where the UEs are located using a MIMO spatial multiplexing mode. Conversely, in embodiments where a UE (e.g., UE 190) has relatively low RSSI and is connected to two adjacent RF tuners, e.g., 160 and 161, the network manager may couple the same port (e.g., port 215) on wireline interface 150 to both RF tuners, such that UE 190 may receive the same antenna signal from both RF tuners 160, 161 to increase signal strength and provides a more robust signal. In embodiments, N×M switch 502 may connect wireline interfaces 150, 152 only to those radio tuners that are coupled to more than one wireless UE involving multi-user MIMO transmission. It is noted that such assignments may be performed without delays and may be dynamically altered, e.g., in each beacon interval or in each packet and/or depending on UE location, usage pattern, and other parameters and characteristics, e.g., to assign different antennas or antenna signals to different RF tuners 160-165.

In embodiments, the connections between UEs 190-192 and RF tuners 160-165 may be learned by analyzing the per-antenna RSSI of different UEs or, for example, by progressively turning off RF tuners 160-165, reducing their transmit power, and other techniques. In embodiments, connection parameters between UEs 190-192 and RF tuners 160-165 may be measured by sensors embedded in RF tuners 160-165. Suitable sensors may be equipped with wireless transceiver's capabilities, e.g., to measure RSSI of signals from different UEs. This may be accomplished, for example, by analyzing control messages from different UEs or by operating in a promiscuous or monitoring mode. In embodiments that do not utilize N×M switch 502, the network manager may improve a connection between wireline interfaces 150-152 and RF tuners 160-165 and notify a user (e.g., network administrator) to manually update the connections.

In embodiments, the transmission power of wireline interfaces for RF ports 215-220 in headend unit 130 or RF tuners 160-165 may be adapted based on interference measurements and/or change in the coverage pattern. In embodiments, interference may be measured at headend unit 130. It is noted that, in embodiments, the network manager may obtain measured power from all wireline interfaces to correlate that information with available interference information. Advantageously, power adaptation may be used to reduce the creation of interference to nearby wireless transceivers, especially in implementations that use unshielded cables. In embodiments, when no signal is transmitted in the wireline, the power of received interference signal may be measured at each wireline interface at headend unit 130 and/or RF tuner(s) 160-165. In embodiments, interference power may be more accurately obtained, e.g., by correlating it with interference information, such as frequency and power for an installation location. For example, by using public information on the frequency of FM services at a given location. Further, if the measured interference power is above a threshold, transmit power may be lowered, for example by an amount equal to the difference between the measured power and the threshold. Furthermore, if the power cannot be sufficiently lowered, the carrier frequency for the wireline interface may be moved such as to prevent the wireline signal from overlapping with the measured interference.

In embodiments, the network manager may obtain the information on the wireless coverage changes. For example, if one of the access points adjacent to one of the RF tuners fails, an area without wireless coverage emerges. When the network manager learns that such area emerges, the network manager may instruct the RF tuner closest to such area without wireless coverage to increase the transmit power. Advantageously, such per RF tuner power control does not affect the coverage area adjacent to other RF tuners, thus preventing interference or coverage conflict issues caused if the coverage is increased uniformly to all areas covered by an access point like most of the wireless access point do.

In embodiments, the transmission frequency at the RF transceivers may be adapted based on the measured interference signal. For example, a newly added Wi-Fi access point may start transmission in one of the RF tuner's coverage area. This new access point will cause interference with the RF tuner and other RF tuners that share the same frequency band. In embodiments, headend unit 130, e.g., in response to detecting the presence of interference, may perform an interference measurement. In response, the network manager may adjust one or more operating conditions, such as transmit power, connection configurations at N×M switch 502, and the like, e.g., to associate the observed interference with the RF tuner. The network manager may further correlate the measured interference power, the location of the interferer (i.e., the location of the RF tuner affected by the interfering device), and the location of neighboring wireless APs under its management, e.g., to determine a more suitable Wi-Fi frequency or perform any other mitigation tasks. Furthermore, when changing a Wi-Fi frequency, the network manager may instruct headend unit 130 and RF tuners (e.g., 160) to change frequency synchronously with each other, e.g., to prevent a loss of the wireline signal.

In embodiments, the network manager may resolve a hidden node problem by updating N×M switch 502. To accomplish this, the network manager may monitor the presence of a hidden node problem, for example by analyzing statistics related to collisions (such as packet error, carrier sensing, etc.). Once a hidden node problem is detected, RF tuners that received the signal from stations involving the hidden node problem may be identified, for example by the network manager instructing RF tuners to change their mode of operation (e.g., transmission power) or by using a sensor embedded in the RF tuners. In embodiments, identified RF tuners may be assigned to different wireline interfaces for RF ports such that wireless transceiver 135 at headend unit 130 receives signals from those stations involved in the hidden node problem with different RF ports, which makes it easier for the wireless transceiver 135 to resolve collisions.

It is noted that, each wireline interface (e.g., 150) may be used to transmit more than one signal by using TDM, FDM, SDM, or any other known multiplexing method known in the art, such as logical multiplexing.

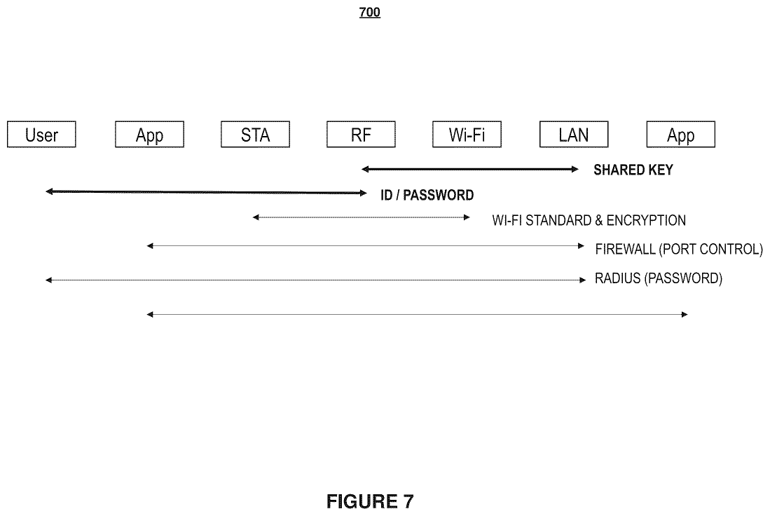

FIG. 7 illustrates physical layer security according to various embodiments of the present disclosure. As discussed with reference to FIG. 1, an RF module may comprise an authenticator unit that may be used to obtain a unique ID or password from a user to authenticate the user to the RF module. Similarly, the RF module itself may is a unique ID, such as a shared key, to authenticate itself to a network (e.g., an access controller, centralized management server, etc.) using, e.g., a LAN connection, e.g., prior to a wireless signal at the RF tuner being enabled. It is noted that any number of components in the network may use one or more other authentication methods, inducing encryption methods, to be authenticated.

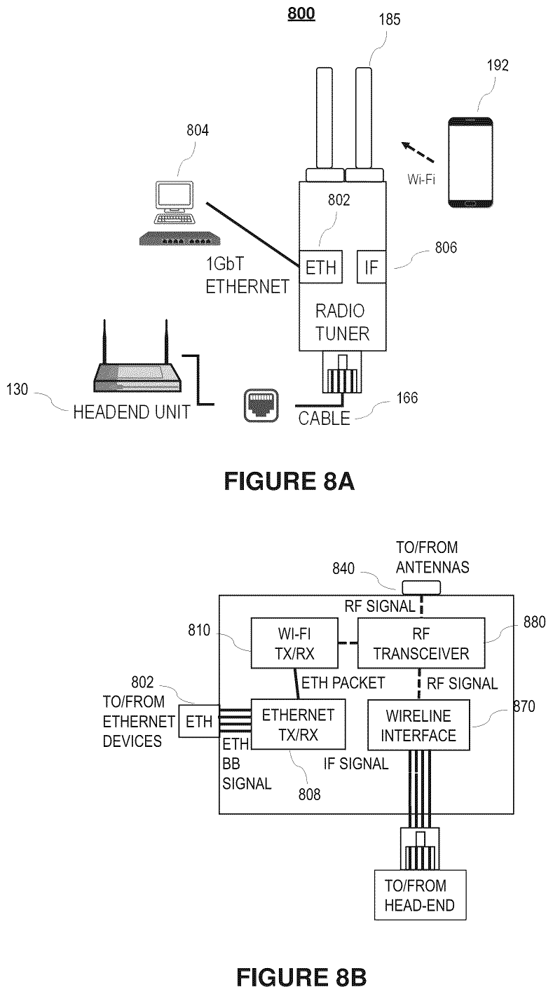

FIG. 8A illustrates a system that utilizes a radio tuner that allows common Ethernet devices to be combined with and share a connection to a headend unit according to various embodiments of the present disclosure. As depicted, system 800 may comprise RF tuner 160, UE 192, incumbent devices such as a peripheral device (e.g., printer) 804, cable 166, and headend unit 130. RF tuner 860 may further comprise wireline interface port 806 that exchanges wireline signals with another RF tuner. In embodiments, RF tuner 860 may comprise Ethernet port 802 to which incumbent device 804 may be connected and one or more antennae (e.g., 185). In embodiments, RF tuner 860 receives Ethernet packets at Ethernet port 802, e.g., from a printer, and converts the packets to a Wi-Fi signal according to various embodiments herein. The Wi-Fi signal may then be converted to an RF signal that is combined with an RF signal that has been received by antenna 185. The combined (e.g., logically multiplexed) RF signals are then converted to a wireline signal prior to being passed to headend unit 130.

FIG. 8B is an exemplary block diagram for the exemplary radio tuner shown in FIG. 8A. As depicted, radio tuner 860 comprises Ethernet transceiver 808, Wi-Fi transceiver 810, wireless interface 870, RF transceiver 880, and antenna port 840. It is noted that Ethernet signals need not physically coexist with wireline signals in RF tuner 860. Instead, in embodiments, Ethernet packets may be converted to a Wi-Fi signal, and then to a wireline signal that is then sent to a headend unit, where they are converted back to Ethernet packages. By preserving L2/L3 settings for Ethernet, the incumbent Ethernet devices continue to operate seamlessly.

In operation, Ethernet transceiver 808 may provide Ethernet packets received at Ethernet port 802 to Wi-Fi transceiver 810 that converts the Ethernet packets into an RF signal. In embodiments, Ethernet transceiver 808 may first decode Ethernet packets to obtain raw Ethernet frames prior to providing them to Wi-Fi transceiver 810. In response to receiving the Ethernet frames, Wi-Fi transceiver 810 may generate a Wi-Fi signal that is input to RF transceiver 880. RF transceiver 880 may combine the Wi-Fi signal with Wi-Fi signals received from one or more antennae at port 840, e.g., by using a simple power divider (not shown) such that a Wi-Fi MAC at Wi-Fi transceiver 810 can resolve collisions/resource allocation. In embodiments, RF transceiver 880 may comprise dedicated hardware that is used to prioritize RF signals converted from Ethernet transceiver 808 connected to Ethernet port 802 over RF signals from wireless UEs obtained at antenna port 840. For example, a dedicated switch may be used to select between Wi-Fi transceiver 810 and antenna port 840.

In embodiments, in response to receiving the RF signal, RF transceiver 880 may combine the RF signal received from Wi-Fi transceiver 810 with the RF signal received from antenna 185 to output a combined RF signal to wireline interface 870. Wireline interface 870 may use the combined RF signal to generate a wireline signal therefrom, according to various embodiments herein. In embodiments, RF transceiver 880 and/or wireline interface 870 may multiplex RF signals within radio tuner 860 prior to communicating them to headed unit 130.

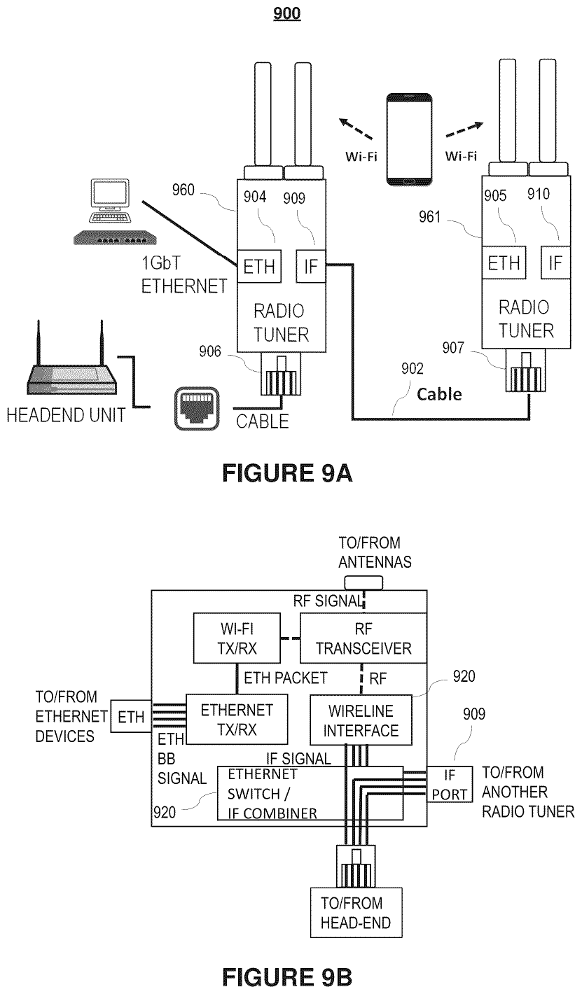

FIG. 9A illustrates a system of cascaded radio tuners according to various embodiments of the present disclosure. FIG. 9B is an exemplary block diagram of radio tuner 1 shown in FIG. 9A. As depicted in FIG. 9A. system 900 comprises RF tuners 960 (denoted as RF tuner 1) and 961 (denoted as RF tuner 2), respectively, that may be coupled to each other via cable 902. In a manner similar to RF tuner 960 shown in FIG. 8A, each RF tuner 960, 961 in FIG. 9A may comprise respective Ethernet ports 904, 905, wireline signal output ports 906, 907, and wireline signal input ports 909, 910. In embodiments, the output signal of RF tuner 961 is transmitted, via cable 902, from wireline signal output port 907 of RF tuner 961 to wireline signal input port 909 of RF tuner 960, e.g., the incumbent radio tuner. In this manner, any number of RF tuners may be coupled within the physical layer, e.g., to provide Wi-Fi access to any number of Wi-Fi enabled devices. It is noted that although embodiments described herein are framed in the context of Wi-Fi devices, a person skilled in the art will appreciate that the concepts of the present disclosure are not limited to any particular protocol or technology. For example, the teachings of the present disclosure may equally be used in other contexts, such as in 5G applications.

In embodiments, to accomplish this each RF tuner may comprise an Ethernet switch and IF combiner circuit, denoted as numeral 930 in FIG. 9B. The Ethernet switch portion of circuit 930 may handle Ethernet signals, whereas the wireline combiner portion of circuit 930 may be implemented as a power combiner that adds the wireline signals received from wireline interface 970 and cable 902. Advantageously, this allows additional radio tuners to be cascaded to incumbent radio tuner 960.

It is noted that, in embodiments, no wireline signal multiplexer or demultiplexer circuit is needed as their functions may be performed, e.g., by a MIMO receiver/transmitter algorithm at a wireless transceiver (not shown). It is further noted that the systems illustrated in FIGS. 1-2, 4-6, and 8A-9B are not limited to the constructional detail shown there or described in the accompanying text. As those skilled in the art will appreciate, a suitable information handling system may comprise more or less components, such as signal processing devices (e.g., ADCs, amplifiers, up/down converters, Wi-Fi controllers, etc.) and other auxiliary components and sub-systems that may be used to accomplish the objectives of the present disclosure.

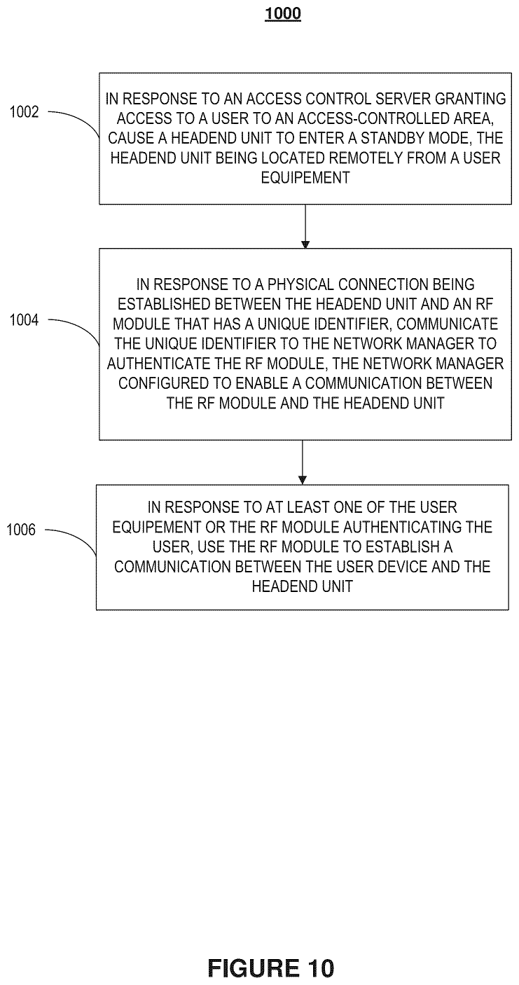

FIG. 10 is a flowchart of an illustrative process for using a headend unit to establish a communication to a remotely located user equipment in accordance with various embodiments of the present disclosure. In embodiments, process 1000 for using the headend unit may start at step 1002 when, in response to an access control server granting access to a user to an access-controlled area, a headend unit is placed in a standby mode. The headend unit may be located remotely from a user equipment. At step 1004, in response to a physical connection being established between the headend unit and an RF module, which may have has a unique identifier, the unique identifier may be communicated to a network manager, such as that depicted in FIG. 2. The network manager may authenticate the RF module and, in embodiments, enable a communication between the RF module and the headend unit. Finally, at step 1006, in in response to at least one of the user equipment or the RF module authenticating the user, the RF module may be used to establish a communication between the user equipment and the headend unit. One skilled in the art shall recognize that: (1) certain steps may optionally be performed; (2) steps may not be limited to the specific order set forth herein; (3) certain steps may be performed in different orders; and (4) certain steps may be done concurrently.

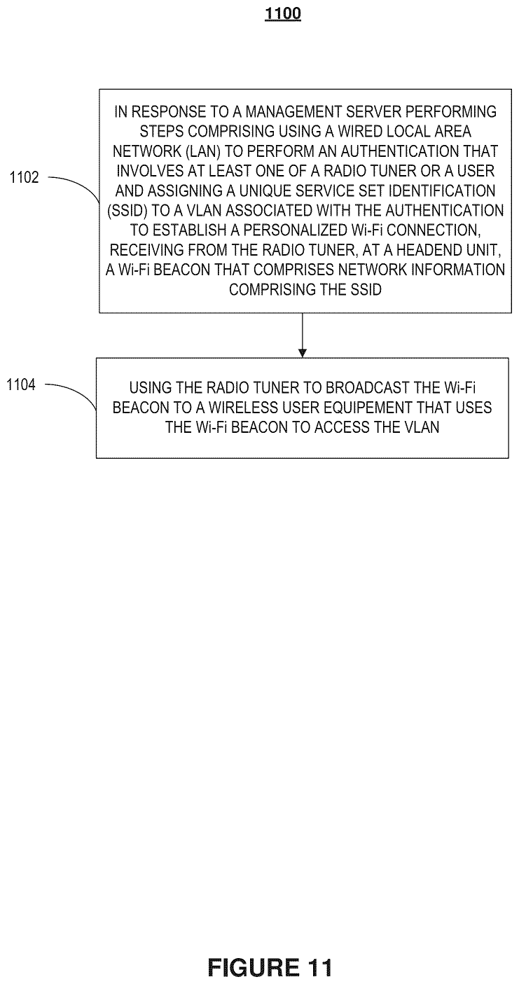

FIG. 11 is a flowchart of an illustrative process for forming a personalized VLAN, the method comprising in accordance with various embodiments of the present disclosure. In embodiments, process 1100 for forming a personalized VLAN may begin at step 1102 when, in response to a management server performing steps comprising: (1) using a wired LAN to perform an authentication that involves at least one of a radio tuner or a user and (2) assigning a unique SSID to a VLAN associated with the authentication to establish a personalized Wi-Fi connection, a headend unit may receive, from the radio tuner, a Wi-Fi beacon that comprises network information comprising the SSID. It is understood that the personalized Wi-Fi connection may comprise one or more users (e.g., a group of users) present in a coverage area in proximity to the radio tuner.

At step 1104, the headend unit may use the radio tuner to broadcast the Wi-Fi beacon to a wireless user equipment that uses the Wi-Fi beacon to access the VLAN. In embodiments, the Wi-Fi beacon, which may be detected by the wireless user equipment that uses the SSID therein, may be pre-shared (e.g., together with a password) with the management server to access the VLAN, e.g., by using a conventional Wi-Fi association and/or authentication method.

Further, in embodiments, the SSID for accessing a personalized VLAN may be associated with a user equipment in response to a user authentication process using a wireline connection after the user equipment has been successfully associated with an SSID using a conventional wireless Wi-Fi association or authentication process. Advantageously, using an RF tuner according to various embodiments herein, which has both wireline and wireless interfaces, allows for greatly simplified and nearly instant access, e.g., without the user equipment having to switch between different SSIDs. In addition, unlike conventional APs that require BSSID changes for handovers between physically distinct APs, no upper layer handover is required between RF tuners, e.g., in settings that are not necessarily personalized, since signal aggregation and signal processing by the headend unit makes communication with any number of RF tuners seamless and free of the restrictions of conventional roaming.

In embodiments, by adjusting transmit power and/or range data rates, with which a radio tuner sends beacon packets, may be reduced to essentially match the effective range of payload packets, thereby, preventing access to beacon packets and, thus, control channel information from extending beyond the range for authorized user equipments. For example, to increase network security and thwart attacks that exploit information carried in beacon signals, a headend unit may instruct an RF tuner, such as that shown in FIG. 8A to adjust transmit power and/or data rates such as to align the range of beacon packets with the range of payload packets. It is understood that suitable margins for the range of beacon packets may be applied to accommodate multiple user equipments, e.g., devices associated with a same user. Further, unlike conventional systems, embodiments herein may adjust beacon MCS levels based on a user's MCS level, as discussed next.

A conventional AP sends beacon frames comprising an SSID at the lowest basic data rate (e.g., 6 Mbps or 12 Mbps) to maintain a connection reliably. This basic rate determines the transmission rate of the beacon signal and is usually lower than that used for payload packets. The basic rate is specified in the basic rate field of the beacon frame and also advertises the MCS level that the AP supports. Conventional systems use low MCS for beacon packages such that the beacon is available to potential users farther from the AP. However, by transmitting the beacon at the minimum rate (e.g., to ensure better coverage at extended distances since the minimum rate offers enhanced reliability in the context of Wi-Fi connectivity), the beacons the AP sends can be decoded at distance farther from the AP as compared to the range of the user equipment. This is due to the fact that a lower MCS simply requires less SNR for successful decoding.

Therefore, in various embodiments herein, a Wi-Fi AP may reduce transmit power and configure the minimum rate in the basic rate field, e.g., to 100 Mbps, while keeping the MCS level at 100 Mbps, thereby, preventing the transmitted signal from extending much beyond the range of the user equipment, e.g., in line with the same rate as user traffic. For example, transmit power for beacon signals may be reduced, such that the range of a 6 Mbps beacon is essentially the same as the range for 100 Mbps user traffic. Stated differently, unlike conventional systems, the range of beacon signals may be adjusted by adjusting any combination of transmit transmission power and/or basic rate, e.g., by taking into consideration the range disparity between payload MCS and beacon MCS.

In embodiments, to reduce a relatively large disparity in range, transmission power may be adjusted in addition to increasing to the lowest basic rate. Common basic rates for devices are limited to, e.g., 1, 2, 5.5, 11, 18, 24, 36, 48, or 54 Mbps over a 20 MHz bandwidth. Assuming a UE transmits user traffic at the highest rate of 54 Mbps, corresponding to a relatively small signal range, an RF tuner may align that range with the range of beacon traffic, e.g., by applying the same transmit power to both or by increasing the basic, i.e., minimum rate for beacon traffic, e.g., from a default 11 Mbps to 54 Mbps. Assuming a payload that uses 216 Mbps over an 80 MHz bandwidth, it would require a 6 dB higher SNR, and the range would be about 0.64 times that of the range for the 54 Mbps beacon. However, given that 54 Mbps is already the highest rate for that particular beacon traffic, the beacon signal range cannot be further reduced by increasing the basic rate. Therefore, in embodiments, to further reduce beacon signal range, an RF tuner may reduce the transmit power of beacon signals to be (here, 6 dB) lower than that for user traffic.

In embodiments, aspects of the present patent document may be directed to, may include, or may be implemented on one or more information handling systems/computing systems. A computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, phablet, personal digital assistant (PDA), smart phone, smart watch, smart package, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, ROM, and/or other types of memory. Additional components of the computing system may include one or more disk drives, one or more network ports for communicating with external devices as well as various input and output (I/O) devices, such as a keyboard, a mouse, touchscreen and/or a video display. The computing system may also include one or more buses operable to transmit communications between the various hardware components.

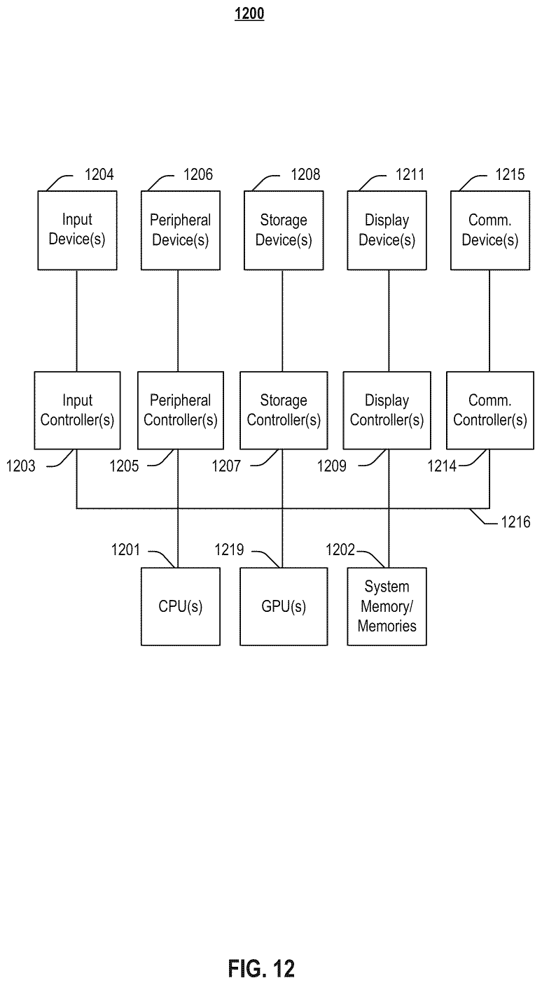

FIG. 12 depicts a simplified block diagram of a computing device/information handling system (or computing system) according to embodiments of the present disclosure. It will be understood that the functionalities shown for system 1200 may operate to support various embodiments of a computing system—although it shall be understood that a computing system may be differently configured and include different components, including having fewer or more components as depicted in FIG. 12.

As illustrated in FIG. 12, the computing system 1200 includes one or more central processing units (CPU) 1201 that provides computing resources and controls the computer. CPU 1201 may be implemented with a microprocessor or the like, and may also include one or more graphics processing units (GPU) 1219 and/or a floating-point coprocessor for mathematical computations. System 1200 may also include a system memory 1202, which may be in the form of random-access memory (RAM), read-only memory (ROM), or both.

A number of controllers and peripheral devices may also be provided, as shown in FIG. 12. An input controller 1203 represents an interface to various input device(s) 1204, such as a keyboard, mouse, touchscreen, and/or stylus. The computing system 1200 may also include a storage controller 1207 for interfacing with one or more storage devices 1208 each of which includes a storage medium such as magnetic tape or disk, or an optical medium that might be used to record programs of instructions for operating systems, utilities, and applications, which may include embodiments of programs that implement various aspects of the present invention. Storage device(s) 1208 may also be used to store processed data or data to be processed in accordance with the invention. The system 1200 may also include a display controller 1209 for providing an interface to a display device 1211, which may be a cathode ray tube (CRT), a thin film transistor (TFT) display, organic light-emitting diode, electroluminescent panel, plasma panel, or other type of display. The computing system 1200 may also include one or more peripheral controllers or interfaces 1205 for one or more peripherals 1206. Examples of peripherals may include one or more printers, scanners, input devices, output devices, sensors, and the like. A communications controller 1214 may interface with one or more communication devices 1215, which enables the system 1200 to connect to remote devices through any of a variety of networks including the Internet, a cloud resource (e.g., an Ethernet cloud, an Fiber Channel over Ethernet (FCoE)/Data Center Bridging (DCB) cloud, etc.), a LAN, a wide area network (WAN), a storage area network (SAN) or through any suitable electromagnetic carrier signals including infrared signals.

In the illustrated system, all major system components may connect to a bus 1216, which may represent more than one physical bus. However, various system components may or may not be in physical proximity to one another. For example, input data and/or output data may be remotely transmitted from one physical location to another. In addition, programs that implement various aspects of the invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Aspects of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A method for using a headend unit to establish a communication to a remote user equipment, the method comprising:
in response to a physical connection being established between a headend unit, which is located remotely from a user equipment, and a radio frequency (RF) module that has a unique identifier, communicating the unique identifier to a network manager to authenticate the RF module; and
in response to a user authentication being successful, using the RF module to establish a communication between the user equipment and the headend unit.

2. The method of claim 1, wherein the user authentication is performed by at least one of the user equipment, the RF module, or the network manager.

3. The method of claim 2, wherein the user authentication by the network manager comprises receiving, at the network manager, authentication information that has been obtained, at the RF module.

4. The method of claim 1, further comprising at least partially encrypting the communication, the physical connection being a wired LAN connection.

5. The method of claim 1, wherein, in response to an access control server granting access to a user to an access-controlled area, the headend unit enters a standby mode.

6. The method of claim 1, further comprising using the headend unit to detect the physical connection.

7. The method of claim 1, further comprising receiving, at an IF port of the RF tuner, a signal from another RF tuner and combining that signal with the IF signal.

8. A radio frequency (RF) tuner configured to communicate with a wireless user equipment, the RF tuner comprising:
an antenna that receives a radio wave from a user equipment;
an RF transceiver that, in response to receiving the radio wave, generates an RF signal;
a wireline interface coupled to the RF transceiver, the wireline interface, in response to receiving the RF signals outputs a wireline signal; and
a connector that is removably coupled to a cable to establish a physical connection between the RF tuner and a headend unit that is located remotely from the RF tuner, the physical connection configured to communicate at least one of the unique identifier, the wireline signal, or a control signal to a network manager or a wireless transceiver, which enables a communication between the user equipment and the headend unit.

9. The RF tuner of claim 8, wherein the network manager uses the unique identifier to authenticate the RF tuner prior to enabling the communication.

10. The RF tuner of claim 8, wherein the RF tuner is integrated in an RF module that further comprises an authentication module that, in response to receiving authentication information, performs an authentication operation to authenticate the user.

11. The RF module of claim 10, wherein authenticating the user comprises communicating the authentication information to the network manager.

12. The RF module of claim 10, wherein the authentication information is generated by the user equipment.

13. The RF module of claim 10, wherein the authentication information comprises at least one of a biometric ID, a password, a passcode, a fingerprint ID, or a facial ID.

14. The RF tuner of claim 8, further comprising an Ethernet transceiver that, at an Ethernet port, exchanges Ethernet packets with an Ethernet device.

15. The RF tuner of claim 8, further comprising a Wi-Fi transceiver coupled to the Ethernet transceiver and the RF transceiver, wherein the Wi-Fi transceiver converts the Ethernet packets into a Wi-Fi signal or vice versa.

16. The RF tuner module of claim 8, further comprising an IF port coupled to the wireline interface to generate a combined IF signal that is provided to the headend unit.

17. A headend unit comprising:
a set of wireline transceivers that receive data packets from transport network and generate a first set of radio frequency (RF) signals that are provided to a set of RF ports, the set of wireline transceivers further providing a control signal;
a wireline interface coupled to the wireless transceiver, the wireline interface comprising:
a control signal conditioner that converts the control signal received from the wireless transceiver; and
an RF signal conditioner that converts the first set of RF signals to a first set of wireline signals that are output by the set of wireline transceivers, the set of wireline transceivers performing steps comprising:
receiving a second wireline signal that has been generated by an RF tuner;
converting the second wireline signal to a second set of RF signals; and
providing the second set of RF signals to the wireless transceiver.

18. The headend unit of claim 17, further comprising a switch that maps a same signal of the set of wireline interfaces to one or more cables in a set of cables, each cable being assigned at least one of the first set of wireline signals.

19. The headend unit of claim 17, further comprising a switch that maps a same signal of the first set of wireline interfaces to one cable in a set of cables.

20. The wireline interface of claim 17, wherein the control signal conditioner receives, from a PoE Ethernet switch, Ethernet packets and power that are output to a cable by the set of wireline transceivers.
